(19) United States
(12) Patent Application Publication
(10) Pub. No.: US 2024/0218930 A1
(43) Pub. Date: Jul. 4, 2024

(54) SELF ENERGIZED SEAL AND METHODS OF MAKING AND USING THE SAME

(71) Applicant: SAINT-GOBAIN PERFORMANCE PLASTICS CORPORATION, Solon, OH (US)

(72) Inventors: Filip ROUSSEAU, Aartselaar (BE); Zamzam Golmohammadi, Riverside, RI (US); Christian Elz, Unterpleichfeld (DE); Jean-Marie Lebrun, Versailles (FR); Herman M. Dubois, Duffel (BE); Beatrice De Gennaro, Dardilly (FR)

(21) Appl. No.: 18/397,761

(22) Filed: Dec. 27, 2023

Related U.S. Application Data
(60) Provisional application No. 63/478,006, filed on Dec. 30, 2022.

(51) Int. Cl. F16J 15/3232

(52) U.S. Cl. CPC F16J 15/3232

(57) ABSTRACT

A seal including: an annular jacket including an annular jacket including a body including a heel, a first lip, and a second lip defining an annular recess oriented down a central axis, where the first lip is substantially parallel to the central axis, where the second lip includes an angled portion adjacent to the heel and a planar portion adjacent to the angled portion, where the angled portion forms an angle, α, with a line perpendicular to the central axis, where α is between 30 and 90°, where the heel has an axial length, L_{H}, where the first lip has an axial length, L_{FL}, and where L_{H}≤3 L_{FL}.

### CROSS-REFERENCE TO RELATED APPLICATION(S)

This application claims priority under 35 U.S.C. § 119(e) to U.S. Provisional Application No. 63/478,006, entitled “SELF ENERGIZED SEAL AND METHODS OF MAKING AND USING THE SAME,” by Filip ROUSSEAU et al., filed Dec. 30, 2022, which is assigned to the current assignee hereof and incorporated herein by reference in its entirety.

### FIELD OF THE DISCLOSURE

The present disclosure relates to seals, and more particularly to annular seals, or seals adapted to be disposed in pressure conditions.

### RELATED ART

Seals are employed in environments to segregate fluids (liquids, gases, slurries, etc.) from one another. Often, these seals must show minimal leakage under strict pressure requirements in broad temperature ranges. Often, wear and leakage issues with seals arise during cycles of low to high fluid pressure and temperature in applications. Conventionally, energizers are used to provide the sealing contact force required for these applications, however, these energized seals can be expensive and require delicate handling. Alternatively, in some cases, these seals may be self energized, which does not require an energizing element (e.g., spring), however, they may not provide the wear and leakage performance desired in certain applications. Therefore, the industry continues to demand improved seals capable of withstanding broader pressure and temperature conditions while maintaining operational effectiveness in contact force, contact area, and ultimately leakage performance over time.

### SUMMARY

Embodiments herein may include a seal including: an annular jacket including a body including a heel, a first lip, and a second lip defining an annular recess oriented down a central axis, where the first lip is substantially parallel to the central axis, where the second lip includes an angled portion adjacent to the heel and a planar portion adjacent to the angled portion, where the angled portion forms an angle, α, with a line perpendicular to the central axis, where α is between 30° and 90°, where the heel has an axial length, L_{H}, where the first lip has an axial length, L_{FL}, and where L_{H}≤3 L_{FL}.

Embodiments herein may include a seal assembly including: a first member; a second member; and a seal disposed between the first member and the second member, the seal including: an annular jacket including a body including a heel, a first lip, and a second lip defining an annular recess oriented down a central axis, where the first lip is substantially parallel to the central axis, where the heel is adapted to deform down the central axis to form an angle, β, with a line perpendicular to the central axis, where β is greater than 3°.

Embodiments herein may include a seal assembly including: an annular jacket including a body including a heel, a static first lip, and a dynamic second lip defining an annular recess oriented down a central axis, where the first lip is substantially parallel to the central axis, where a contact force of the second lip against the moving shaft measured after completion of Test 1 is in a range between about 1 and about 25 N/mm, and where a wear length on the second lip measured after completion of Test 1 is bigger than about 0.1 mm and smaller than about 2.5 mm.

### BRIEF DESCRIPTION OF THE DRAWINGS

Embodiments are illustrated by way of example and are not intended to be limited in the accompanying figures.

FIG. 1A includes a cross-sectional perspective view of a seal in accordance with an embodiment.

FIG. 1B includes a cross-sectional perspective view of a seal in accordance with an embodiment.

FIG. 1C includes a perspective view of a seal in accordance with an embodiment.

FIG. 2 includes a cross-sectional perspective view of a seal assembly in accordance with an embodiment.

FIG. 3A illustrates a first iteration of a design of a seal as formed and under strain after being introduced within an assembly in accordance with an embodiment.

FIG. 3B illustrates a second iteration of a design of a seal as formed and under strain after being introduced within an assembly in accordance with an embodiment.

FIG. 3C illustrates a third iteration of a design of a seal as formed and under strain after being introduced within an assembly in accordance with an embodiment.

FIG. 3D illustrates a fourth iteration of a design of a seal as formed and under strain after being introduced within an assembly in accordance with an embodiment.

FIG. 3E illustrates a fifth iteration of a design of a seal as formed and under strain after being introduced within an assembly in accordance with an embodiment.

FIG. 4A illustrates a graph of contact force (N) over time (hr) of the seals of FIGS. 3A-3E within sealing assemblies at ambient temperature according to various embodiments.

FIG. 4B illustrates a graph of contact area (mm²) over time (hr) of the seals of FIGS. 3A-3E within sealing assemblies at ambient temperature according to various embodiments.

FIG. 5A illustrates a graph of contact force (N) over time (hr) of the seals of FIGS. 3A-3E within sealing assemblies at ambient temperature according to various embodiments.

FIG. 5B illustrates a graph of contact area (mm²) over time (hr) of the seals of FIGS. 3A-3E within sealing assemblies at ambient temperature according to various embodiments.

Skilled artisans appreciate that elements in the figures are illustrated for simplicity and clarity and have not necessarily been drawn to scale. For example, the dimensions of some of the elements in the figures may be exaggerated relative to other elements to help to improve understanding of embodiments of the invention.

### DETAILED DESCRIPTION

The following description in combination with the figures is provided to assist in understanding the teachings disclosed herein. The following discussion will focus on specific implementations and embodiments of the teachings. This focus is provided to assist in describing the teachings and should not be interpreted as a limitation on the scope or applicability of the teachings. However, other embodiments can be used based on the teachings as disclosed in this application.

The terms “comprises,” “comprising,” “includes,” “including,” “has,” “having” or any other variation thereof, are intended to cover a non-exclusive inclusion. For example, a method, article, or apparatus that comprises a list of features is not necessarily limited only to those features but may include other features not expressly listed or inherent to such method, article, or apparatus. Further, unless expressly stated to the contrary, “or” refers to an inclusive-or and not to an exclusive-or. For example, a condition A or B is satisfied by any one of the following: A is true (or present) and B is false (or not present), A is false (or not present) and B is true (or present), and both A and B are true (or present).

Also, the use of “a” or “an” is employed to describe elements and components described herein. This is done merely for convenience and to give a general sense of the scope of the invention. This description should be read to include one, at least one, or the singular as also including the plural, or vice versa, unless it is clear that it is meant otherwise. For example, when a single item is described herein, more than one item may be used in place of a single item. Similarly, where more than one item is described herein, a single item may be substituted for that more than one item.

Unless otherwise defined, all technical and scientific terms used herein have the same meaning as commonly understood by one of ordinary skill in the art to which this invention belongs. The materials, methods, and examples are illustrative only and not intended to be limiting. To the extent not described herein, many details regarding specific materials and processing acts are conventional and may be found in textbooks and other sources within the sealing arts.

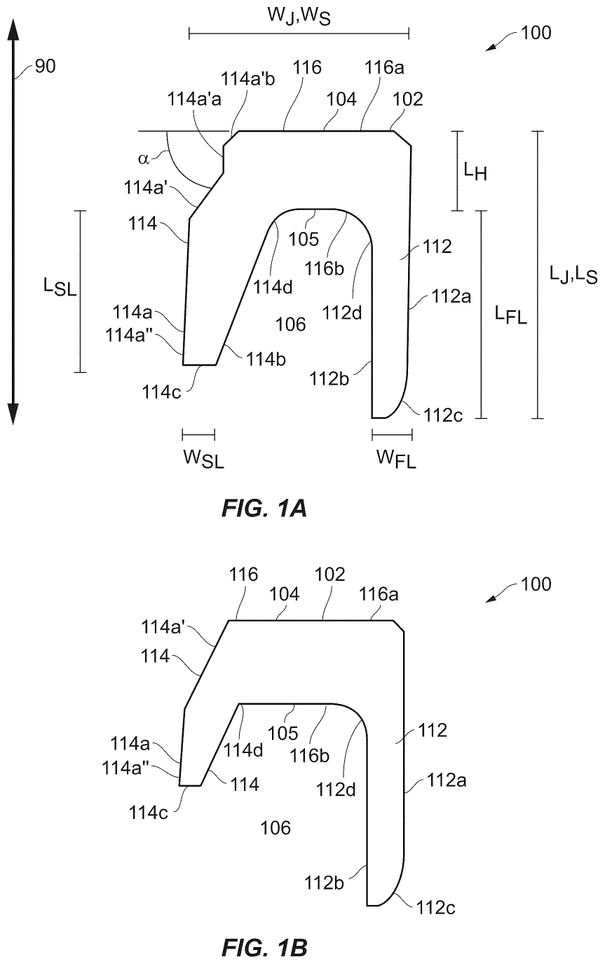

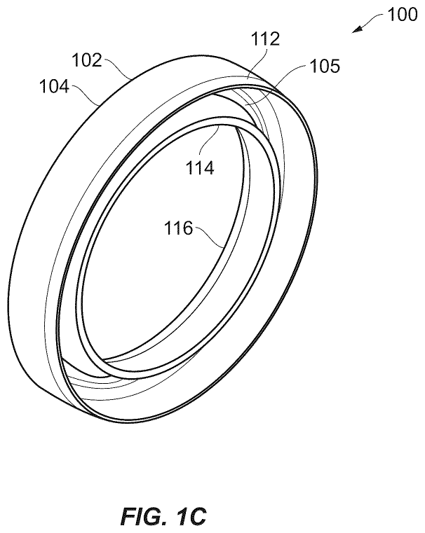

FIGS. 1A-1B illustrate a cross-sectional perspective view of a seal in accordance with a number of embodiments. FIG. 1C illustrates a perspective view of a seal in accordance with a number of embodiments. Referring initially to FIG. 1, a seal 100 in accordance with some embodiments described herein can generally include a jacket 102. The jacket 102 may be annular around a central axis 190. The jacket 102 can include a body 104 having a heel 116, a first lip 112, and a second lip 114. In an embodiment, the body 104 may include an inner sidewall 105 that can define an annular recess 106.

In a number of embodiments, the seal 100 may be a self-energized seal (i.e. not include a spring or energizer). Upon a loading condition, the jacket 102 may be self-energized to deform in a radial direction. Resultantly, the lips 112, 114 of the jacket 102 may provide an outward force against a neighboring component (e.g., first and second member respectively) within an assembly.

The seal 100 can be formed from any suitable material in the sealing arts. In a particular embodiment, the seal 100 can at least partially include a polymer. The polymer may be selected from the group including a polyketone, a polyaramid, a polyphenylene sulfide, a polyethersulfone, a polypheylene sulfone, a polyamideimide, ultra high molecular weight polyethylene, a fluoropolymer, a polybenzimidazole, a polyacetal, polybutylene terephthalate (PBT), polypropylene (PP), polycarbonate (PC), Acrylonitrile butadiene styrene (ABS), polyethylene terephthalate (PET), a polyimide (PI), polyetherimide, polyetheretherketone (PEEK), polyethylene (PE), a polysulfone, a polyamide (PA), polyphenylene oxide, polyphenylene sulfide (PPS), a polyurethane, a polyester, a liquid crystal polymer (LCP), an elastomer, or any combination thereof. The polymer may be a thermoplastic or thermosetting polymer. In an embodiment, the jacket 102 may include, or even consist essentially of, a fluoropolymer. Exemplary fluoropolymers include a polytetrafluoroethylene (PTFE), a fluorinated ethylene propylene (FEP), a polyvinylidene fluoride (PVDF), a perfluoroalkoxy (PFA), a terpolymer of tetrafluoroethylene, a hexafluoropropylene and vinylidene fluoride (THV), a polychlorotrifluoroethylene (PCTFE), an ethylene tetrafluoroethylene copolymer (ETFE), an ethylene chlorotrifluoroethylene copolymer (ECTFE), or any combination thereof. Other fluoropolymers, polymers, and blends may be included in the composition of the jacket 102. In another particular embodiment, the seal 100 can at least partially include, or even consist essentially of, a polyethylene (PE) such as an ultra-high-molecular-weight polyethylene (UHMWPE). In another particular embodiment, the seal 100 may include a thermoplastic elastomeric hydrocarbon block copolymer, a polyether-ester block co-polymer, a thermoplastic polyamide elastomer, a thermoplastic polyurethane elastomer, a thermoplastic polyolefin elastomer, a thermoplastic vulcanizate, an olefin-based co-polymer, an olefin-based ter-polymer, a polyolefin plastomer, or combinations thereof. In an embodiment, the seal 100 may include a styrene based block copolymer such as styrene-butadiene, styrene-isoprene, blends or mixtures thereof, and the like. Exemplary styrenic thermoplastic elastomers include triblock styrenic block copolymers (SBC) such as styrene-butadiene-styrene (SBS), styrene-isoprene-styrene (SIS), styrene-ethylene butylene-styrene (SEBS), styrene-ethylene propylene-styrene (SEPS), styrene-ethylene-ethylene-butadiene-styrene (SEEBS), styrene-ethylene-ethylene-propylene-styrene (SEEPS), styrene-isoprene-butadiene-styrene (SIBS), or combinations thereof. Commercial examples include some grades of Kraton™ and Hybrar™ resins. In an embodiment, the seal 100 may include an elastomer including at least one of Acrylonitrile-Butadiene (NBR) Carboxylated Nitrile (XNBR) Ethylene Acrylate (AEM, Vamac®), Ethylene Propylene Rubber (EPR, EPDM), Butyl Rubber (IIR), Chloroprene Rubber (CR), Fluorocarbon (FKM, FPM), Fluorosilicone (FVMQ), Hydrogenated Nitrile (HNBR), Perfluoroelastomer (FFKM), Polyacrylate (ACM), Polyurethane (AU, EU), Silicone Rubber (Q, MQ, VMQ, PVMQ), Tetrafluoroethylene-Propylene (AFLAS®) (FEPM). In a number of embodiments, the seal 100 may be formed from any conventional methods known for polymer manufacturing, such as injection molding or CNC machining.

In an embodiment, the seal 100 can be treated, impregnated, filled, or coated with a lubricious material. Exemplary lubricious materials include molybdenum disulfide, tungsten disulfide, graphite, grapheme, expanded graphite, boron nitrade, talc, calcium fluoride, or any combination thereof. Additionally, the lubricious material can include alumina, silica, titanium dioxide, calcium fluoride, boron nitride, mica, Wollastonite, silicon carbide, silicon nitride, zirconia, carbon black, pigments, or any combination thereof.

In an embodiment, the seal 100 can at least partially include a metal. According to certain embodiments, the metal may include iron, copper, titanium, tin, aluminum, alloys thereof, or may be another type of metal. In an embodiment, the seal 100 can include a metal (such as aluminum, zinc, copper, magnesium, tin, platinum, titanium, tungsten, iron, bronze, steel, energizer steel, stainless steel), a metal alloy (including the metals listed), an anodized metal (including the metals listed), or any combination thereof.

As stated above, the seal 100 may include a jacket 102. The jacket 102 may include a plurality of lips 112, 114 defining an annular recess 106. In a particular instance, the lips 112 and 114 can extend from the heel 116 of the body 104. In a particular embodiment, the lips 112 and 114 can extend from the heel 116 in a generally same direction relative to one another. In an embodiment, the first lip 112 may be located radially exterior to the second lip 114 (e.g., the second lip 114 forms the outer diameter of the seal 100). In another particular embodiment, the lips 112 and 114 can extend parallel with respect to one another. In an embodiment, the first lip 112 may be substantially parallel to the central axis 190. In an embodiment, the second lip 114 may include an angled portion and a planar portion as described below. In an optional embodiment, either or both of the lips 112 and 114 can include a skived lip (not illustrated) adapted to provide a scraper interface for sealing abrasive or viscous material, or environmental components such as dirt, debris, and environmental fluids. In a particular embodiment, the heel 116 can be secured to a hardware (e.g., a valve housing or a shaft) to prevent the seal 100 from turning relative to the hardware within an assembly.

In an embodiment, the heel 116 of the jacket 102 can be generally rectilinear or planar. The heel 116 may include an exterior surface portion 116a and an interior surface portion 116b. That is, the heel 116 may lie generally along a plane with minimal surface undulation and deviation. In a more particular embodiment, the heel 116 of the jacket 102 can be planar. As described in greater detail below, the planar, or generally planar, heel 116 of the jacket 102 may facilitate improved contact between adjacent seals thereby providing a better sealing characteristic. In a number of embodiments the heel 116 may have a rectilinear or polygonal cross-section. In a number of embodiments the heel 116 may have an arcuate cross-section. In a number of embodiments the heel 116 may be oriented substantially perpendicular to at least one of the first lip 112 or the second lip 114 along a central axis 190. In a number of embodiments the heel 116 may have a rectilinear or polygonal portion contiguous with the first lip 112. In a number of embodiments the heel 116 may have an arcuate portion contiguous with the first lip 112. In a number of embodiments the heel 116 may have a rectilinear or polygonal portion contiguous with the second lip 114. In a number of embodiments the heel 116 may have an arcuate portion contiguous with the second lip 114.

In an embodiment, at least one of the lips 112 and 114 can include a rectilinear or planar shape. In an embodiment, at least one of the lips 112 and 114 can include an arcuate shape. As shown in FIGS. 1A-1C, in an embodiment, the first lip 112 may include a generally rectilinear outer surface portion 112a with an arcuate end portion 112c. As shown in FIGS. 1A-1C, in an embodiment, the first lip 112 may include a generally rectilinear inner surface portion 112b with an arcuate inner portion 112d contiguous with the inner surface 116 of the heel 116 defining the recess 106.

As shown in FIGS. 1A-1C, in an embodiment, the second lip 114 may include a generally rectilinear outer surface portion 114a that may include a first sloped surface portion 114a′ (i.e. angled portion) and a second sloped surface portion 114a″ (i.e. planar portion) adjacent to the first sloped surface portion 114a′ (i.e. angled portion). The second lip may also include a rectilinear end portion 114c. As shown in FIG. 1A, the first sloped surface portion 114a′ may include a step 114a′a. The step 114a′a may be substantially parallel to the central axis 190. The step 114a′a may form an interface with an exterior surface of the heel 116 along a shoulder 114a′b. As shown in FIGS. 1A-1C, in an embodiment, the second lip 114 may include a generally rectilinear inner surface portion 114b with an arcuate inner portion 114d contiguous with the inner surface 116b of the heel 116 defining the recess 106. In an embodiment, the entirety of the second lip 114 may be rectilinear.

As shown in FIGS. 1A-1B, the first sloped surface 114a′ of the second lip 114 may form an angled portion adjacent to and meeting the exterior surface 116a of the heel 116 at an angle α, where a may be less than 90°, such as less than 75°, such as less than 60°, such as less than 45°, or such as less than 30°. In an embodiment, a may be between 30° and 90°. It will be further appreciated that a may be any value between any of the minimum and maximum values noted above. The first sloped surface 114a′ (i.e. angled portion) may likewise meet the second sloped surface 114a″ (i.e. planar portion).

In an embodiment, the exterior portion of the first lip 112 may have a radius of curvature, R_{FE}. As shown in FIGS. 1A-1B, the radius of curvature R_{FE} may be formed on the end portion 112c of the first lip 112. In a number of embodiments, the exterior portion of the first lip 112 may have a radius of curvature R_{FE} that may be positive. In a number of embodiments, the exterior portion of the first lip 112 may have a radius of curvature R_{FE} that may be greater than 0.1 mm, such as greater than 0.5 mm, such as greater than 1 mm, such as greater than 2 mm, such as greater than 5 mm, such as greater than 10 mm, such as greater than 20 mm, such as greater than 25 mm, such as greater than 50 mm, such as greater than 100 mm, or such as greater than 200 mm. In a number of embodiments, the exterior portion of the first lip 112 may have a radius of curvature R_{FE} that may be negative. In a number of embodiments, the exterior portion of the first lip 112 may have a radius of curvature R_{FE} that may be less than −0.1 mm, such as less than −0.5 mm, such as less than −1 mm, such as less than −2 mm, such as less than −5 mm, such as less than −10 mm, such as less than −20 mm, such as less than −25 mm, such as less than −50 mm, such as less than −100 mm, or such as less than −200 mm. It will be further appreciated that the exterior portion of the first lip 112 may have a radius of curvature R_{FE} that may be any value between any of the minimum and maximum values noted above. It can also be appreciated that the exterior portion of the first lip 112 may have a radius of curvature R_{FE} that may vary along its circumference and length.

In an embodiment, the interior portion of the first lip 112 may have a radius of curvature, R_{FI}. As shown in FIGS. 1A-1B, the radius of curvature R_{FI} may be formed on the inner portion 112d of the first lip 112. In a number of embodiments, the interior portion of the first lip 112 may have a radius of curvature R_{FI} that may be positive. In a number of embodiments, the interior portion of the first lip 112 may have a radius of curvature R_{FI} that may be greater than 0.1 mm, such as greater than 0.5 mm, such as greater than 1 mm, such as greater than 2 mm, such as greater than 5 mm, such as greater than 10 mm, such as greater than 20 mm, such as greater than 25 mm, such as greater than 50 mm, such as greater than 100 mm, or such as greater than 200 mm. In a number of embodiments, the interior portion of the first lip 112 may have a radius of curvature R_{FI} that may be negative. In a number of embodiments, the interior portion of the first lip 112 may have a radius of curvature R_{FI} that may be less than −0.1 mm, such as less than −0.5 mm, such as less than −1 mm, such as less than −2 mm, such as less than −5 mm, such as less than −10 mm, such as less than −20 mm, such as less than −25 mm, such as less than −50 mm, such as less than −100 mm, or such as less than −200 mm. It will be further appreciated that the interior portion of the first lip 112 may have a radius of curvature R_{FI} that may be any value between any of the minimum and maximum values noted above. It can also be appreciated that the interior portion of the first lip 112 may have a radius of curvature R_{FI} that may vary along its circumference and length.

In an embodiment, the exterior portion of the second lip 114 may have a radius of curvature, R_{FS}. In a number of embodiments, the exterior portion of the second lip 114 may have a radius of curvature R_{FS} that may be positive. In a number of embodiments, the exterior portion of the second lip 114 may have a radius of curvature R_{FE} that may be greater than 0.1 mm, such as greater than 0.5 mm, such as greater than 1 mm, such as greater than 2 mm, such as greater than 5 mm, such as greater than 10 mm, such as greater than 20 mm, such as greater than 25 mm, such as greater than 50 mm, such as greater than 100 mm, or such as greater than 200 mm. In a number of embodiments, the exterior portion of the second lip 114 may have a radius of curvature R_{FS} that may be negative. In a number of embodiments, the exterior portion of the second lip 114 may have a radius of curvature R_{FS} that may be less than −0.1 mm, such as less than −0.5 mm, such as less than −1 mm, such as less than −2 mm, such as less than −5 mm, such as less than −10 mm, such as less than −20 mm, such as less than −25 mm, such as less than −50 mm, such as less than −100 mm, or such as less than −200 mm. It will be further appreciated that the exterior portion of the second lip 114 may have a radius of curvature R_{FS} that may be any value between any of the minimum and maximum values noted above. It can also be appreciated that the exterior portion of the second lip 114 may have a radius of curvature R_{FS} that may vary along its circumference and length.

In an embodiment, the interior portion of the second lip 114 may have a radius of curvature, R_{FT}. As shown in FIGS. 1A-1B, the radius of curvature R_{FT} may be formed on the inner portion 114d of the second lip 114. In a number of embodiments, the interior portion of the second lip 114 may have a radius of curvature R_{FT} that may be positive. In a number of embodiments, the interior portion of the second lip 114 may have a radius of curvature R_{FT} that may be greater than 0.1 mm, such as greater than 0.5 mm, such as greater than 1 mm, such as greater than 2 mm, such as greater than 5 mm, such as greater than 10 mm, such as greater than 20 mm, such as greater than 25 mm, such as greater than 50 mm, such as greater than 100 mm, or such as greater than 200 mm. In a number of embodiments, the interior portion of the second lip 114 may have a radius of curvature R_{FT} that may be negative. In a number of embodiments, the interior portion of the second lip 114 may have a radius of curvature R_{FT} that may be less than −0.1 mm, such as less than −0.5 mm, such as less than −1 mm, such as less than −2 mm, such as less than −5 mm, such as less than −10 mm, such as less than −20 mm, such as less than −25 mm, such as less than −50 mm, such as less than −100 mm, or such as less than −200 mm. It will be further appreciated that the interior portion of the second lip 114 may have a radius of curvature R_{FI} that may be any value between any of the minimum and maximum values noted above. It can also be appreciated that the interior portion of the second lip 114 may have a radius of curvature R_{FT} that may vary along its circumference and length.

In an embodiment, the cavity formed from the annular recess 106 along the interior surface 105 of the first lip 112, the second lip 114, and the heel 116 may have a radius of curvature, RC_{C}. In a number of embodiments, the cavity may have a radius of curvature RC_{C} that may be positive. In a number of embodiments, the cavity may have a radius of curvature RC_{C} that may be greater than 0.1 mm, such as greater than 0.5 mm, such as greater than 1 mm, such as greater than 2 mm, such as greater than 5 mm, such as greater than 10 mm, such as greater than 20 mm, such as greater than 25 mm, such as greater than 50 mm, such as greater than 100 mm, or such as greater than 200 mm. In a number of embodiments, the cavity may have a radius of curvature RC_{C} that may be negative. In a number of embodiments, the cavity may have a radius of curvature RC_{C} that may be less than −0.1 mm, such as less than −0.5 mm, such as less than −1 mm, such as less than −2 mm, such as less than −5 mm, such as less than −10 mm, such as less than −20 mm, such as less than −25 mm, such as less than −50 mm, such as less than −100 mm, or such as less than −200 mm. It will be further appreciated that the cavity may have a radius of curvature RC_{C} that may be any value between any of the minimum and maximum values noted above. It can also be appreciated that the cavity may have a radius of curvature R_{FT} that may vary along its interior surface 105 length.

In an embodiment, the jacket 102 may have an axial length L_{J} of at least 0.1 mm, at least 0.5 mm, at least 1 mm, at least 5 mm, at least 10 mm, at least 25 mm, at least 50 mm, at least 75 mm, at least 100 mm, at least 150 mm, at least 250 mm, at least 500 mm. The jacket 102 may have a length Li that may be no greater than 2000 mm, no greater than 1500 mm, or no greater than 1000 mm. In a number of embodiments, the jacket 102 may have a length Li of between 0.1 mm and 600 mm. It will be further appreciated that the jacket 102 may have a length L_{J} that may be any value between any of the minimum and maximum values noted above. It can also be appreciated that the jacket 102 may have a length L_{J} that may vary along its circumference. In a number of embodiments, the jacket 102 may have a length L_{J} that may be the same as the overall length, L_{S}, of the seal 100 itself.

In an embodiment, the jacket 102 may have a radial width W_{J} of at least 0.1 mm, at least 0.5 mm, at least 1 mm, at least 5 mm, at least 10 mm, at least 25 mm, at least 50 mm, at least 75 mm, at least 100 mm, at least 150 mm, at least 250 mm, at least 500 mm. The jacket 102 may have a width W_{J} that may be no greater than 2000 mm, no greater than 1500 mm, or no greater than 1000 mm. In a number of embodiments, the jacket 102 may have a width W_{J} of between 0.1 mm and 600 mm. It will be further appreciated that the jacket 102 may have a width W_{J} that may be any value between any of the minimum and maximum values noted above. It can also be appreciated that the jacket 102 may have a width W_{J} that may vary along its circumference. In a number of embodiments, the jacket 102 may have a width W_{J} that may be the same as the overall width, W_{S}, of the seal 100 itself.

In an embodiment, the first lip 112 may have an axial length L_{FL} of at least 0.1 mm, at least 0.3 mm, at least 1 mm, at least 5 mm, at least 10 mm, at least 25 mm, at least 50 mm, at least 75 mm, at least 100 mm, at least 150 mm, at least 250 mm, at least 500 mm. The first lip 112 may have a length L_{FL} that may be no greater than 1500 mm or no greater than 1000 mm. In a number of embodiments, the first lip 112 may have a length L_{FL} of between 0.1 mm and 300 mm. It will be further appreciated that the first lip 112 may have a length L_{FL} that may be any value between any of the minimum and maximum values noted above. It can also be appreciated that the first lip 112 may have a length L_{FL} that may vary along its circumference.

In an embodiment, the first lip 112 may have a radial width W_{FL} of at least 0.01 mm, at least 0.1 mm at least 1 mm, at least 5 mm, at least 10 mm, at least 25 mm, at least 50 mm, at least 75 mm, at least 100 mm, at least 150 mm, at least 250 mm, at least 500 mm. The first lip 112 may have a width W_{FL} that may be no greater than 1500 mm, no greater than 1000 mm. In a number of embodiments, the first lip 112 may have a width W_{FL} of between 0.1 mm and 30 mm. It will be further appreciated that first lip 112 may have a width W_{FL} that may be any value between any of the minimum and maximum values noted above. It can also be appreciated that the first lip 112 may have a width W_{FL} that may vary along its circumference.

In an embodiment, the first lip 112 may have a ratio of length L_{FL} to width W_{FL} of at least 2:1, such as 3:1, such as 4:1, such as 5:1, such as 10:1, such as 12:1, such as 15:1, such as 25:1 or such as 50:1. It will be further appreciated that first lip 112 may have a ratio of length L_{F} to width W_{FL} that may be any value between any of the minimum and maximum values noted above. It can also be appreciated that the first lip 112 may have a ratio of length L_{FL} to width W_{FL} that may vary along its circumference.

In an embodiment, the second lip 114 may have an axial length L_{SL} of at least 0.1 mm, at least 0.3 mm, at least 1 mm, at least 5 mm, at least 10 mm, at least 25 mm, at least 50 mm, at least 75 mm, at least 100 mm, at least 150 mm, at least 250 mm, at least 500 mm. The second lip 114 may have a length L_{SL} that may be no greater than 1500 mm or no greater than 1000 mm. In a number of embodiments, the second lip 114 may have a length L_{SL} of between 0.1 mm and 300 mm. It will be further appreciated that the second lip 114 may have a length L_{SL} that may be any value between any of the minimum and maximum values noted above. It can also be appreciated that the second lip 114 may have a length L_{SL} that may vary along its circumference.

In an embodiment, the second lip 114 may have a radial width W_{SL} of at least 0.01 mm, at least 0.1 mm, at least 1 mm, at least 5 mm, at least 10 mm, at least 25 mm, at least 50 mm, at least 75 mm, at least 100 mm, at least 150 mm, at least 250 mm, at least 500 mm. The second lip 114 may have a width W_{SL} that may be no greater than 1500 mm or no greater than 1000 mm. In a number of embodiments, the second lip 114 may have a width W_{SL} of between 0.1 mm and 30 mm. It will be further appreciated that second lip 114 may have a width W_{SL} that may be any value between any of the minimum and maximum values noted above. It can also be appreciated that the second lip 114 may have a width W_{SL} that may vary along its circumference.

In an embodiment, the second lip 114 may have a ratio of length L_{SL} to width W_{SL} of at least 2:1, such as 3:1, such as 4:1, such as 5:1, such as 10:1, such as 12:1, such as 15:1, such as 25:1 or such as 50:1. It will be further appreciated that second lip 114 may have a ratio of length L_{SL} to width W_{SL} that may be any value between any of the minimum and maximum values noted above. It can also be appreciated that the second lip 114 may have a ratio of length L_{SL} to width W_{SL} that may vary along its circumference. In a number of embodiments, as shown in FIG. 1, the widths of the two lips 112, 114 may differ.

In an embodiment, the heel 116 may have an axial length L_{H} of at least 0.1 mm, at least 0.2 mm, at least 1 mm, at least 5 mm, at least 10 mm, at least 25 mm, at least 50 mm, at least 75 mm, at least 100 mm, at least 150 mm, at least 250 mm, at least 500 mm. The heel 116 may have a length L_{H} that may be no greater than 1500 mm or no greater than 1000 mm. In a number of embodiments, the heel 116 may have a length L_{H} of between 0.1 mm and 300 mm. It will be further appreciated that the heel 116 may have a length L_{H} that may be any value between any of the minimum and maximum values noted above. It can also be appreciated that the heel 116 may have a length L_{H} that may vary along its circumference.

In an embodiment, the heel 116 may have a radial width W_{H} of at least 0.1 mm, at least 0.5 mm, at least 1 mm, at least 5 mm, at least 10 mm, at least 25 mm, at least 50 mm, at least 75 mm, at least 100 mm, at least 150 mm, at least 250 mm, at least 500 mm. The heel 116 may have a width W_{H} that may be no greater than 1500 mm or no greater than 1000 mm. In a number of embodiments, the heel 116 may have a width W_{H} of between 0.5 mm and 40 mm. It will be further appreciated that heel 116 may have a width W_{H} that may be any value between any of the minimum and maximum values noted above. It can also be appreciated that the heel 116 may have a width W_{H} that may vary along its circumference.

In an embodiment, the first lip 112 may have a ratio of length L_{FL} to length L_{H} of the heel 116 of at least 2:1, such as 3:1, such as 4:1, such as 5:1, such as 10:1, such as 12:1, such as 15:1, such as 25:1 or such as 50:1. It will be further appreciated the first lip 112 may have a ratio of length L_{FL} to length L_{H} of the heel 116 may be any value between any of the minimum and maximum values noted above. It can also be appreciated that the first lip 112 may have a ratio of length L_{FL} to length L_{H} of the heel 116 that may vary along its circumference. In a particular embodiment, L_{H}≤3 L_{FL}.

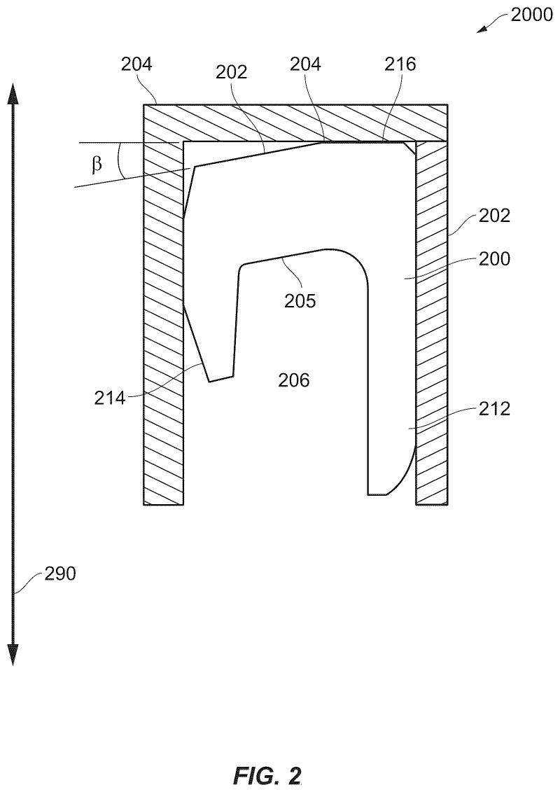

FIG. 2 includes a cross-sectional perspective view of a seal assembly in accordance with an embodiment. Although FIG. 2 illustrates the seal 200 in an axial orientation, the seal 200 could be oriented in any potential orientation including radial or face sealing orientations. The seal 200 may have the same components listed above regarding FIG. 1 and labeled in the 200's instead of the 100's correspondingly. As shown in FIG. 2, the seal 200 may be placed between a first member 202 and a second member 204 within a seal assembly 2000 down a central axis 290. The first member 202 may be a housing. The second member 204 may be a shaft. At least one of the first member 202 or second member 204 may actuate relative to at least one of the seal 200 or the other of the first member 202 or second member 204. The actuation may be a rotational, radial, or axial movement. In an embodiment, at least one of the first or second lip 212, 214 may be static while the other of the first or second lip 212, 214 may be dynamic within the seal assembly. In a particular embodiment, the first lip 212 is static against the housing 202 while the second lip 214 is dynamic against the shaft 204. Further, the first member 202 may be made of a material having different material or mechanical properties (e.g., a different expansion coefficient than the second member 204 or vice versa).

In a number of embodiments, the seal 200 may be fit within a seal assembly 2000. As shown, the seal 200 may expand to fit within the members 202, 204. In a number of embodiments, FIG. 2 may illustrate a second configuration that may show seal deformation of the seal 200 as described in further detail below. As shown in FIG. 2, the second lip 214 may be deformed to include an arcuate outer surface and/or an arcuate inner surface. As shown in FIG. 2, the heel 216 of the seal 200 may deform and form an angle β with a line perpendicular to the central axis 290. In a number of embodiments, β may be at least 10, such as at least 2°, such as at least 3°, such as at least 4°, such as at least 5°, such as at least 6°, such as at least 7°, such as at least 8°, such as at least 9°, or such as at least 10°. In a number of embodiments, β may be less than 45°, such as less than 30°, such as less than 20°, such as less than 10°, or such as less than 5°. In an embodiment, β may be greater than 3°. It will be further appreciated that β may be any value between any of the minimum and maximum values noted above.

The seal 100 may be adapted for prolonged use at elevated or below elevated pressures within seal assemblies 2000. In an embodiment, the seal 100 may have a desired leakage rate at these pressure values. In a number of embodiments, in these assemblies the cyclic pressure may be greater than 100 MPa, such as greater than 200 MPa, such as greater than 500 MPa, or such as greater than 750 Mpa. In a number of embodiments, in these assemblies the cyclic pressure may be less than 500 MPa, such as less than 250 MPa, such as less than 200 MPa, less than 150 MPa less than 100 MPa, less than 50 MPa, less than 10 MPa, less than 1 MPa, less than 0.5 MPa, less than 0.3 MPa, or less than 0.1 MPa. It will be further appreciated that the cyclic pressure may be any value between any of the minimum and maximum values noted above.

The seal 100 may be adapted for prolonged use at elevated or below elevated temperatures within seal assemblies 2000. In an embodiment, the seal 100 may have a desired leakage rate at these temperature values. In a number of embodiments, in these assemblies the temperature may be greater than 25° C., such as greater than 50° C., such as greater than 100° C., or such as greater than 150° C. In a number of embodiments, in these assemblies the cyclic pressure may be less than 50° C., such as less than 25° C., such as less than 0° C., less than −25° C. or less than −50° C. It will be further appreciated that temperature may be any value between any of the minimum and maximum values noted above.

The seal 200 may provide a biasing contact force, F_{S}, against at least one of first member 202 or the second member 204. Specifically, the seal 200 may provide a biasing force, F_{S}, against at least one of first member 202 or the second member 204, thereagainst. In a particular embodiment, the seal 200 may provide a biasing force, F_{S}, against at least one of first member 202 or the second member 204 can be at least 0.001 N/mm, such as at least 0.01 N/mm. In another embodiment, the biasing force, F_{S}, can be less than 5000 N/mm, such as less than 1000 N/mm, such as less than 500 N/mm, less than 400 N/mm, less than 300 N/mm, less than 200 N/mm, less than 100 N/mm, less than 50 N/mm, less than 25 N/mm, or even less than 10 N/mm. In a number of embodiments, the seal 200 may provide a biasing force, F_{S}, against at least one of first member 202 or the second member 204 of between 0.3 N/mm and 150 N/mm. In a number of embodiments, the biasing force, F_{S}, against the first member 202 may be different than the biasing force, F_{Ss}, against the second member 204.

The seal 200 may have a contact area on at least one of first member 202 or the second member 204. In a particular embodiment, the seal 200 may have a contact area on at least one of first member 202 or the second member 204 is at least 0.1% of the total area of the seal 200. In another embodiment, the contact area on at least one of first member 202 or the second member 204 of at least 0.1% of the total area of the seal 200, such as at least 0.5%, such as at least 1%, such as at least 2.5%, such as at least 5%, such as at least 10%, such as at least 15%, such as at least 20%, such as at least 25%, such as at least 30%, such as at least 35%, such as at least 40%, such as at least 45%, such as at least 50%, such as at least 55%, such as at least 60%, such as at least 65%, such as at least 70%, such as at least 75%, or such as at least 80% of the total area of the seal 200.

The seal 200 may have a first lip 112 having a contact area on at least one of first member 202 or the second member 204. In a particular embodiment, the first lip 112 may have a contact area on at least one of first member 202 or the second member 204 is at least 0.1% of the total surface area of the first lip 112. In another embodiment, the contact area of the first lip 112 on at least one of first member 202 or the second member 204 of at least 0.1% of the total surface area of the first lip 112, such as at least 0.5%, such as at least 1%, such as at least 2.5%, such as at least 5%, such as at least 10%, such as at least 15%, such as at least 20%, such as at least 25%, such as at least 30%, such as at least 35%, such as at least 40%, such as at least 45%, such as at least 50%, such as at least 55%, such as at least 60%, such as at least 65%, such as at least 70%, such as at least 75%, or such as at least 80% of the total surface area of the first lip 112. The seal 200 may have a first lip 112 having a contact area on at least one of first member 202 or the second member 204. In a particular embodiment, the first lip 112 may have a contact area on at least one of first member 202 or the second member 204 of at least 0.1% of the total surface area of the first lip 112. In an embodiment, the first lip 112 may have a contact area, CAR, between 0.01 and 3000 mm².

In another embodiment, the contact area of the first lip 112 on at least one of first member 202 or the second member 204 is at least 0.1% of the total surface area of the first lip 112, such as at least 0.5%, such as at least 1%, such as at least 2.5%, such as at least 5%, such as at least 10%, such as at least 15%, such as at least 20%, such as at least 25%, such as at least 30%, such as at least 35%, such as at least 40%, such as at least 45%, such as at least 50%, such as at least 55%, such as at least 60%, such as at least 65%, such as at least 70%, such as at least 75%, or such as at least 80% of the total surface area of the first lip 112.

The seal 200 may have a second lip 114 having a contact area on at least one of first member 202 or the second member 204. In a particular embodiment, the second lip 114 may have a contact area on at least one of first member 202 or the second member 204 is at least 0.1% of the total surface area of the second lip 114. In another embodiment, the contact area of the second lip 114 on at least one of first member 202 or the second member 204 of at least 0.1% of the total surface area of the second lip 114, such as at least 0.5%, such as at least 1%, such as at least 2.5%, such as at least 5%, such as at least 10%, such as at least 15%, such as at least 20%, such as at least 25%, such as at least 30%, such as at least 35%, such as at least 40%, such as at least 45%, such as at least 50%, such as at least 55%, such as at least 60%, such as at least 65%, such as at least 70%, such as at least 75%, or such as at least 80% of the total surface area of the second lip 114. The seal 200 may have a second lip 114 having a contact area on at least one of first member 202 or the second member 204. In a particular embodiment, the second lip 114 may have a contact area on at least one of first member 202 or the second member 204 of at least 0.1% of the total surface area of the second lip 114. In an embodiment, the second lip 114 may have a contact area, CA_{SL}, between 0.01 and 3000 mm².

In another embodiment, the contact area of the second lip 114 on at least one of first member 202 or the second member 204 is at least 0.1% of the total surface area of the first lip 112, such as at least 0.5%, such as at least 1%, such as at least 2.5%, such as at least 5%, such as at least 10%, such as at least 15%, such as at least 20%, such as at least 25%, such as at least 30%, such as at least 35%, such as at least 40%, such as at least 45%, such as at least 50%, such as at least 55%, such as at least 60%, such as at least 65%, such as at least 70%, such as at least 75%, or such as at least 80% of the total surface area of the first lip 112.

Test 1 is a measure of the contact force of the second lip 214 of the seal 200 against a moving shaft 204 when installed within an annulus between the first member 202 and the second member 204. Test 1 consists of a sequence of cycles to be performed in determined conditions (during Test 1, contact force is not monitored). To perform the Test 1, the seal may have an initial inner diameter of between 13.5 mm and 14.6 mm and an initial outer diameter between 17 mm and 21 mm. The annulus may have a groove which fits the seal such that the seal may be installed within the groove. The shaft 204 is moved with a linear reciprocating movement at a speed of between 0.01 m/s and 0.03 m/s for a total distance of 80 km while the seal 200 is fully exposed to a differential pressure of between 0 and 0.3 MPa by means of a fluid (demineralized water) at room temperature. The first member 202 is made of machined polyoxymethylene (POM) polymer and the second member 204 is made of ceramic and has an external diameter of 14.6 mm and a surface finish equivalent to 0.04 μm. After this sequence is completed, the seal is removed and placed on a bench to measure friction force (shaft actuation). A sensor monitors for the friction force needed to actuate the shaft is registered while the seal 200 is in place by means of a load cell connected to the shaft with the maximum value registered during one cycle of shaft movement (dry conditions with no pressure, speed of 0.03 m/s, stroke of 10 mm). Contact force is expressed in N/mm of circumference and calculated from measured friction force divided by the coefficient of friction characterizing the contact between the seal 200 and shaft 204 (0.1) and the dynamic sealing circumference. After Test 1 is completed, the seal 200 is removed and the width of a “wear band” caused by shaft 204 movement is measured on the seal 200. This is measured visually under a microscope on the external side of the dynamic lip 214. The “wear band” is the width of the visual surface damage/wear due to the shaft 204 sliding against the dynamic lip 214. In a number of embodiments, according to Test 1, the seal 200 may have a contact force of the second lip 204 against the moving shaft 204 measured after completion of Test 1 in a range between about 1 and about 25 N/mm, and a wear length on the second lip 214 measured after completion of Test 1 bigger than about 0.1 mm and smaller than about 2.5 mm.

The seal 100 may form an assembly which can be utilized in a bidirectional pressure application. The seal 100 may be oriented and protect against leakage of fluid in a forward axial direction, or the seal 100 may be oriented and protect against leakage of fluid in a backward axial direction down the central axis 190. The seal 100 may be oriented and protect against leakage of fluid in an inward direction, or the seal 100 may be oriented and protect against leakage of fluid in an outward direction in a direction perpendicular to the central axis 190. In this regard, the seal 100 may be selected to have specific characteristics which permit effective sealing in those particular orientations. Particular suitable applications include valves, pistons, bidirectional couplings, and other movable components requiring sealing therebetween.

Seals described according to embodiments herein may allow for the components of the seal to have a longer lifetime due to appropriately placed contact forces that lessen repeat compression and stressing of the self-energized seal due to vibration or actuation of the seal or other components within the assembly. Further, the seal described according to embodiments herein may prevent seal deformation under low and high cyclic pressure and temperature cycles while maintaining sufficient contact forces between the sealing area and the hardware. As a result, the lifetime of the components and the seal itself may be improved and overall leakage may be lessened. Further, the self energized seal according to embodiments herein may be less expensive, more robust in handling, and produce similar performance versus conventional energized seals.

### Examples

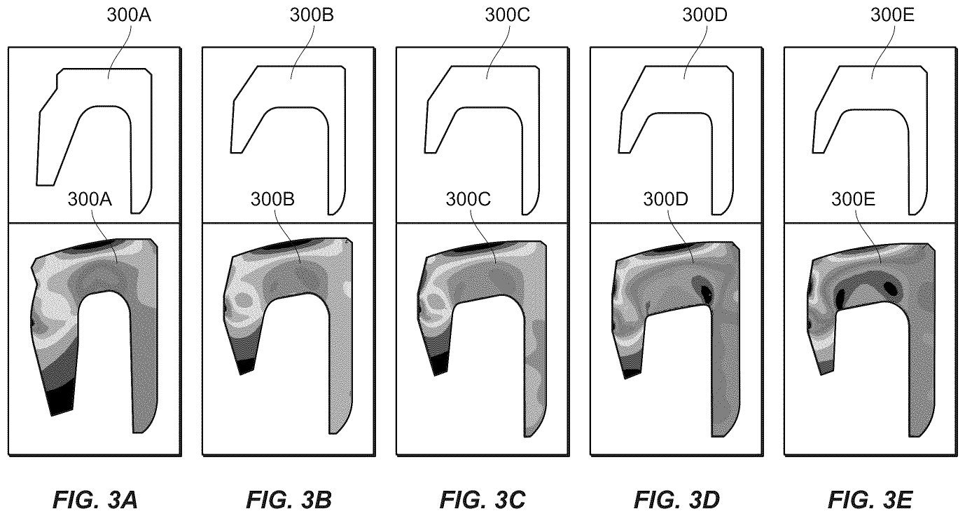

FIG. 3A illustrates a first iteration of a design of a seal as formed and under strain after being introduced within an assembly in accordance with an embodiment. This embodiment, as shown in FIG. 3A, the seal 300A exhibited heavy strain when placed within an assembly. FIG. 3B illustrates a second iteration of a design of a seal as formed and under strain after being introduced within an assembly in accordance with an embodiment. This embodiment, as shown in FIG. 3B, the seal 300B exhibited slightly less heavy strain when placed within an assembly than the seal of FIG. 3A. FIG. 3C illustrates a third iteration of a design of a seal as formed and under strain after being introduced within an assembly in accordance with an embodiment. This embodiment, as shown in FIG. 3C, the seal 300C exhibited slightly less heavy strain when placed within an assembly than the seal of FIG. 3B. FIG. 3D illustrates a fourth iteration of a design of a seal as formed and under strain after being introduced within an assembly in accordance with an embodiment. This embodiment, as shown in FIG. 3D, the seal 300D exhibited slightly less heavy strain when placed within an assembly than the seal of FIG. 3C. FIG. 3E illustrates a fifth iteration of a design of a seal as formed and under strain after being introduced within an assembly in accordance with an embodiment. This embodiment, as shown in FIG. 3E, the seal 300E exhibited slightly less heavy strain when placed within an assembly than the seal of FIG. 3D. As shown, the seal design according to embodiments herein was optimized to provide optimal strain when placed within a seal assembly.

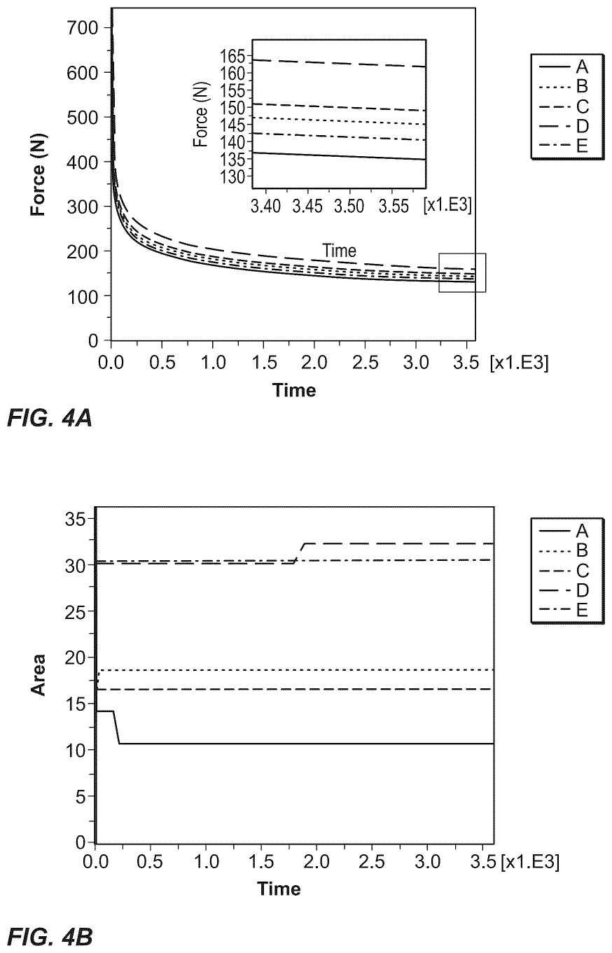

FIG. 4A illustrates a graph of contact force (N) over time (hr) of the seals of FIGS. 3A-3E within sealing assemblies at ambient temperature according to various embodiments. FIG. 4B illustrates a graph of contact area (mm²) over time (hr) of the seals of FIGS. 3A-3E within sealing assemblies at ambient temperature according to various embodiments. As shown in FIGS. 4A-4B, the seals of FIGS. 3D, 3E and embodiments herein exhibited greater contact force and contact area than previous iterations as well as the original design and conventional seals.

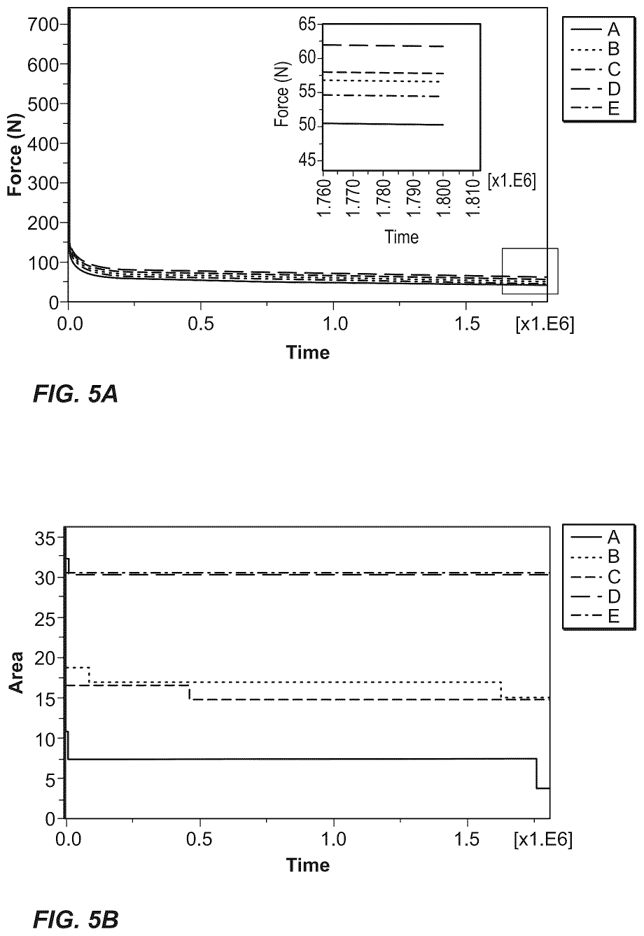

FIG. 5A illustrates a graph of contact force (N) over time (hr) of the seals of FIGS. 3A-3E within sealing assemblies at ambient temperature according to various embodiments. FIG. 5B illustrates a graph of contact area (mm²) over time (hr) of the seals of FIGS. 3A-3E within sealing assemblies at ambient temperature according to various embodiments. As shown in FIGS. 5A-5B, the seals of FIGS. 3D, 3E and embodiments herein exhibited greater contact force and contact area than previous iterations as well as the original design and conventional seals. As shown in FIGS. 4A-5B, the seal design according to embodiments herein was optimized to provide optimal contact force and contact area when placed within a seal assembly and provide surprising results in contact force and contact area because as the angle α, the heel length L_{H}, the width of the first lip W_{FL}, and the cavity profile are modified along the iterations, the seal exhibited stronger performance in contact area and force.

Many different aspects and embodiments are possible. Some of those aspects and embodiments are described below. After reading this specification, skilled artisans will appreciate that those aspects and embodiments are only illustrative and do not limit the scope of the present invention. Embodiments may be in accordance with any one or more of the items as listed below.

Embodiment 1. A seal comprising: an annular jacket comprising a body comprising a heel, a first lip, and a second lip defining an annular recess oriented down a central axis, wherein the first lip is substantially parallel to the central axis, wherein the second lip comprises an angled portion adjacent to the heel and a planar portion adjacent to the angled portion, wherein the angled portion forms an angle, α, with a line perpendicular to the central axis, wherein α is between 30 and 90°, wherein the heel has an axial length, L_{H}, wherein the first lip has an axial length, L_{FL}, and wherein L_{H}≤3 L_{FL}.

Embodiment 2. A seal assembly comprising: a first member; a second member; and a seal disposed between the first member and the second member, the seal comprising: an annular jacket comprising a body comprising a heel, a first lip, and a second lip defining an annular recess oriented down a central axis, wherein the first lip is substantially parallel to the central axis, wherein the heel is adapted to deform down the central axis to form an angle, β, with a line perpendicular to the central axis, wherein β is greater than 3°.

Embodiment 3. A seal assembly comprising: a first member; a second member; and a seal disposed between the first member and the second member, the seal comprising: an annular jacket comprising a body comprising a heel, a static first lip, and a dynamic second lip defining an annular recess oriented down a central axis, wherein the first lip is substantially parallel to the central axis, wherein a contact force of the second lip against the moving shaft measured after completion of Test 1 is in a range between about 1 and about 25 N/mm, and wherein a wear length on the second lip measured after completion of Test 1 is bigger than about 0.1 mm and smaller than about 2.5 mm.

Embodiment 4. The seal assembly according to any one of embodiments 1-2, wherein the first lip is a static lip.

Embodiment 5. The seal assembly according to any one of embodiments 1-2, wherein the second lip is a dynamic lip.

Embodiment 6. The seal of embodiment 1, wherein the first lip has an axial width, W_{FL}, between 0.1 and 30 mm.

Embodiment 7. The seal of embodiment 1, wherein the second lip has an axial width, W_{SL}, between 0.1 and 30 mm.

Embodiment 8. The seal of embodiment 1, wherein the heel has an axial length, L_{H}, between 0.1 and 300 mm.

Embodiment 9. The seal of embodiment 1, wherein the first lip has an axial length, L_{FL}, between 0.1 and 300 mm.

Embodiment 10. The seal of embodiment 1, wherein the second lip has an axial length, L_{SL}, between 0.1 and 300 mm.

Embodiment 11. The seal of embodiment 1, wherein the entirety of the second lip is rectilinear.

Embodiment 12. The seal assembly according to any one of embodiments 2-3, wherein the first lip has a contact area, CA_{F}, between 0.01 and 3000 mm².

Embodiment 13. The seal assembly according to any one of embodiments 2-3, wherein the second lip has a contact area, CA_{SL}, between 0.01 and 3000 mm².

Embodiment 14. The seal assembly according to any one of embodiments 2-3, wherein the seal provides an outward biasing contact force, F_{S}, between 1 and 25 N/mm.

Embodiment 15. The seal or seal assembly according to any one of the preceding embodiments, wherein the cavity has a radius of curvature, RC_{C}, of −200 and 200 mm.

Embodiment 16. The seal assembly according to any one of embodiments 2-3, wherein the second lip is deformed to include an arcuate outer surface.

Embodiment 17. The seal or seal assembly according to any one of the preceding embodiments, wherein the first lip comprises a rectilinear portion and an arcuate end portion adjacent the rectilinear portion.

Embodiment 18. The seal or seal assembly according to any one of the preceding embodiments, wherein the first lip is located exterior to the second lip.

Embodiment 19. The seal or seal assembly according to any one of the preceding embodiments, wherein the seal does not include an energizer.

Embodiment 20. The seal or seal assembly according to any one of the preceding embodiments, wherein the jacket comprises a polymer.

Embodiment 21. The seal or seal assembly according to any one of the preceding embodiments, wherein the jacket comprises a polyethylene or polyetherketone.

Embodiment 22. The seal or seal assembly according to any one of the preceding embodiments, wherein the seal has a length of between 0.1 mm and 600 mm.

Embodiment 23. The seal or seal assembly according to any one of the preceding embodiments, wherein the seal has a width of between 0.1 mm and 600 mm.

Note that not all of the features described above are required, that a portion of a specific feature may not be required, and that one or more features may be provided in addition to those described. Still further, the order in which features are described is not necessarily the order in which the features are installed.

Certain features are, for clarity, described herein in the context of separate embodiments, may also be provided in combination in a single embodiment. Conversely, various features that are, for brevity, described in the context of a single embodiment, may also be provided separately or in any subcombinations.

Benefits, other advantages, and solutions to problems have been described above with regard to specific embodiments, however, the benefits, advantages, solutions to problems, and any feature(s) that may cause any benefit, advantage, or solution to occur or become more pronounced are not to be construed as a critical, required, or essential feature of any or all the claims.

The specification and illustrations of the embodiments described herein are intended to provide a general understanding of the structure of the various embodiments. The specification and illustrations are not intended to serve as an exhaustive and comprehensive description of all of the elements and features of apparatus and systems that use the structures or methods described herein. Separate embodiments may also be provided in combination in a single embodiment, and conversely, various features that are, for brevity, described in the context of a single embodiment, may also be provided separately or in any subcombination. Further, reference to values stated in ranges includes each and every value within that range. Many other embodiments may be apparent to skilled artisans only after reading this specification. Other embodiments may be used and derived from the disclosure, such that a structural substitution, logical substitution, or any change may be made without departing from the scope of the disclosure. Accordingly, the disclosure is to be regarded as illustrative rather than restrictive.

What is claimed is:

1. A seal comprising:
an annular jacket comprising a body comprising a heel, a first lip, and a second lip defining an annular recess oriented down a central axis, wherein the first lip is substantially parallel to the central axis, wherein the second lip comprises an angled portion adjacent to the heel and a planar portion adjacent to the angled portion, wherein the angled portion forms an angle, α, with a line perpendicular to the central axis, wherein α is between 30 and 90°, wherein the heel has an axial length, L_{H}, wherein the first lip has an axial length, L_{FL}, and wherein L_{H}≤3 L_{FL}.

2. A seal assembly comprising:
a first member;
a second member; and
a seal disposed between the first member and the second member, the seal comprising:
an annular jacket comprising a body comprising a heel, a first lip, and a second lip defining an annular recess oriented down a central axis, wherein the first lip is substantially parallel to the central axis, wherein the heel is adapted to deform down the central axis to form an angle, β, with a line perpendicular to the central axis, wherein β is greater than 3°.

3. A seal assembly comprising:
a first member;
a second member; and
a seal disposed between the first member and the second member, the seal comprising:
an annular jacket comprising a body comprising a heel, a static first lip, and a dynamic second lip defining an annular recess oriented down a central axis, wherein the first lip is substantially parallel to the central axis, wherein a contact force of the second lip against the moving shaft measured after completion of Test 1 is in a range between about 1 and about 25 N/mm, and wherein a wear length on the second lip measured after completion of Test 1 is bigger than about 0.1 mm and smaller than about 2.5 mm.

4. The seal assembly according to claim 2, wherein the first lip is a static lip.

5. The seal assembly according to claim 2, wherein the second lip is a dynamic lip.

6. The seal according to claim 1, wherein the first lip has an axial width, W_{FL}, between 0.1 and 30 mm.

7. The seal according to claim 1, wherein the second lip has an axial width, W_{SL}, between 0.1 and 30 mm.

8. The seal according to claim 1, wherein the heel has an axial length, L_{H}, between 0.1 and 300 mm.

9. The seal according to claim 1, wherein the first lip has an axial length, L_{FL}, between 0.1 and 300 mm.

10. The seal according to claim 1, wherein the second lip has an axial length, L_{SL}, between 0.1 and 300 mm.

11. The seal according to claim 1, wherein the entirety of the second lip is rectilinear.

12. The seal assembly according to claim 2, wherein the first lip has a contact area, CA_{FL}, between 0.01 and 3000 mm².

13. The seal assembly according to claim 2, wherein the second lip has a contact area, CA_{SL}, between 0.01 and 3000 mm².

14. The seal assembly according to claim 2, wherein the seal provides an outward biasing contact force, F_{S}, between 1 and 25 N/mm.

15. The seal according to claim 1, wherein the cavity has a radius of curvature, RC_{C}, of −200 and 200 mm.

16. The seal assembly according to claim 2, wherein the second lip is deformed to include an arcuate outer surface.

17. The seal according to claim 1, wherein the first lip comprises a rectilinear portion and an arcuate end portion adjacent to the rectilinear portion.

18. The seal assembly according to claim 2, wherein the first lip is located exterior to the second lip.

19. The seal according to claim 1, wherein the seal does not include an energizer.

20. The seal according to claim 1, wherein the jacket comprises a polymer.
